(19) United States
(12) Patent Application Publication
(10) Pub. No.: US 2025/0208097 A1
(43) Pub. Date: Jun. 26, 2025

(54) TANDEM ION MOBILITY SPECTROMETER AND ION MOBILITY ANALYSIS METHOD

(71) Applicant: SHIMADZU CORPORATION, Kyoto-shi (JP)

(72) Inventors: Wenjian SUN, Shanghai (CN); Xiaoqiang ZHANG, Shanghai (CN)

(21) Appl. No.: 18/991,815

(22) Filed: Dec. 23, 2024

(30) Foreign Application Priority Data
Dec. 26, 2023 (CN) 202311822719.9

(51) Int. Cl. G01N 27/623

(52) U.S. Cl. CPC G01N 27/623

(57) ABSTRACT

The disclosure relates to the field of ion mobility analysis, and particularly provides a tandem ion mobility spectrometer and an ion mobility analysis method. The tandem ion mobility spectrometer incorporates an ion dissociation device into a basic structure of a UMA, enabling ion mobility spectrometric analysis of ions within a target mobility range as well as fragment ions resulting from dissociation of the ions, achieving higher resolution. Additionally, by configuring an electric field in a first channel to allow ions to accumulate therein, when the ions within the target ion mobility range are released, ions outside the target ion mobility range which need to be analyzed can remain stored in the first channel and be released for analysis later, making ion utilization more efficient.

### TECHNICAL FIELD

The disclosure relates to the field of ion mobility analysis, in particular to a tandem ion mobility spectrometer and an ion mobility analysis method.

### BACKGROUND ART

Ion mobility spectrometry is a technique that separates ions based on their mobility. Ion mobility spectrometers are widely used in biological analysis because they can distinguish isomers that mass spectrometry cannot.

In recent years, there have been numerous attempts to couple ion mobility spectrometers with other devices to increase the dimensionality of analysis parameters.

A common approach is to couple ion mobility spectrometers with mass spectrometers in a tandem mass spectrometry setup, further separating different ions based on their mobility characteristics, thereby improving ion identification capabilities. For example, U.S. Pat. No. 9,891,194 combines TIMS technology with DIA/DDA techniques to create a parallel accumulation-serial fragmentation (PASEF) scheme.

In some studies, to enhance the separation efficiency (resolution) of ion mobility spectrometers for ions based on their mobility, the coupling of two ion mobility spectrometers in series has been proposed. U.S. Pat. No. 7,148,474B2 proposes coupling FAIMS and IMS devices based on different physical mechanisms of IMS and FAIMS to achieve greater separation efficiency (resolution).

U.S. Pat. No. 7,855,360B2 proposes a method and device for accurately identifying gas-phase ions using multiple tandem filtering devices. It proposes a series combination of two DMAs to increase the specificity and sensitivity of IMS detection. One of the DMAs at least operates at high electric fields within a range of nonlinear mobility. However, due to the inherent limitations of the filtering mode of DMAs, only ions within the target mobility range can be selected during a single scanning cycle, resulting in the loss of all other ions and leading to a low utilization efficiency of the ions in the DMAs, thus yielding a low overall duty cycle for the system.

Further, for the ion mobility analysis of trace substances in complex mixtures, U.S. Pat. No. 10,794,861B2 proposes a method for analyzing ions and a tandem ion mobility spectrometer suitable for the same. The tandem ion mobility spectrometer comprises two trapped ion mobility spectrometer (TIMS) analyzers connected in series, along with an ion gate and fragmentation unit positioned between the two TIMS analyzers. The tandem TIMS ion mobility spectrometer can first perform pre-separation of ions based on their mobility, and then selectively fragment ions within the target mobility range, allowing for the ion mobility analysis of the resulting fragment ions. TIMS offers high resolution and allows for ion accumulation in the first TIMS, thereby improving the duty cycle of the tandem ion mobility spectrometer.

However, one limitation of the tandem TIMS analyzer is that during the initial selection process of ions within the mobility range in the first TIMS, ions that do not fall within the target mobility range will be lost, preventing further improvement of the duty cycle. Additionally, since TIMS transmits ions in the axial direction, devices such as ion gates need to be placed at the ion outlet of the first TIMS to kill ions outside the target mobility range, which complicates the system configuration.

### SUMMARY OF THE INVENTION

In view of the above problems, the disclosure provides a tandem ion mobility spectrometer and an ion mobility analysis method which can at least solve some of the problems in the prior art.

Previously, the inventor of the present disclosure developed a U-shaped ion mobility analyzer (UMA, CN109003877A), which operates based on the combined effects of gas flow and electric fields on ions. Unlike TIMS, the UMA features two parallel gas flow channels that are perpendicular to a main ion path of a mass spectrometer. Based on this characteristic, a specialized ion control process has been designed to effectively select the ion mobility range of accumulated ions in a first channel of the UMA while also allowing ions outside the ion mobility range to be effectively stored. Furthermore, the non-target ions, which are stored synchronously, do not interfere with the analysis of the current target ions. This approach enables target ions to occupy a larger space, or even the entire first channel, thereby reducing the influence of space charge and improving resolution without significantly sacrificing sensitivity. This ion control process can also be applied to the analysis by the tandem ion mobility spectrometer in this disclosure.

Specifically, in a first aspect of the disclosure, a tandem ion mobility spectrometer is provided, which is refined from UMA. Specifically, the tandem ion mobility spectrometer in this disclosure comprises a hardware structure of UMA, which is composed of a first channel, a second channel, a gas flow supply and a power supply.

The first channel has a first electrode array and a second electrode array which are positioned opposite each other, the first electrode array is provided with an ion inlet, the second electrode array is provided with a first ion transfer port, and the ion inlet and the first ion transfer port are staggered in an extending direction of the first channel. The second channel has a third electrode array and a fourth electrode array which are positioned opposite each other, the third electrode array is provided with a second ion transfer port, the fourth electrode array is provided with an ion outlet, the first ion transfer port is connected with the second ion transfer port, and in an extending direction of the second channel, the ion outlet is disposed in a staggered way on a side, near the ion inlet, of the second ion transfer port.

The gas flow supply supplies gas flow to the first channel and the second channel. The power supply is electrically connected with the first electrode array, the second electrode array, the third electrode array and the fourth electrode array, and configured to apply an electric field force to ions in the first channel and the second channel which is opposite to a direction of a force exerted by the gas flow on the ions.

Particularly, the tandem ion mobility spectrometer in this disclosure further comprises an ion dissociation device configured to receive and dissociate ions from the first channel and release fragment ions generated by dissociation to the second channel.

According to the tandem ion mobility spectrometer provided by the disclosure, ions to be analyzed enter the first channel through the ion inlet. Under the balanced effect of the mutually opposing electric field confinement and gas flow propulsion within the first channel, the qualifying ions move along the first channel toward the first ion transfer port and are arranged in the first channel in order of ion mobility. Subsequently, ions within a target ion mobility range are deflected and released through the first ion transfer port. After receiving the ions released from the first ion transfer port, the ion dissociation device dissociates the ions to generate fragment ions, which enter the second channel, and ion mobility analysis is conducted on the fragment ions under the balanced effect of the mutually opposing electric field confinement and gas flow propulsion within the second channel. In this way, those skilled in the art can freely select and adjust the electric field intensity distribution applied to the first channel and the second channel as needed, and the ion mobility analysis of ions and fragment ions resulting from ion dissociation can be completed in two channels of a UMA device with higher resolution.

When the ions within the target ion mobility range are released from the first channel, the remaining ions to be analyzed outside the target ion mobility range can remain stored in the first channel and be released for analysis later, making ion utilization more efficient. For ions which do not require analysis, adjustments to the electric field strength and gas flow within the first channel can be made to allow disqualified ions to flow out from two ends of the first channel, effectively filtering them out. This eliminates the need for additional ion gates along the ion migration path and does not affect the movement of ions within the first channel.

In an alternative technical scheme of the disclosure, the power supply is configured to:
apply a first electric field to the first channel during a first time period, causing ions within a target mobility range to accumulate in a target ion enrichment region of the first channel, and at least part of ions outside the target mobility range to accumulate in a non-target ion enrichment region located at an end of the first channel; and
apply a second electric field to the first channel during a second time period, causing at least part of ions accumulating in the non-target ion enrichment region during the first time period to move toward and pass through the first ion transfer port.

According to the tandem ion mobility spectrometer of this disclosure, when the ions within the target mobility range are captured in the first channel and conveyed to the first ion transfer port, at least some of the ions outside the target mobility range are not lost but are stored in the target ion enrichment region of the first channel. The target ion enrichment region may be positioned at either end of the first channel or simultaneously at both ends.

During the second time period, the target ion mobility range of the target ion enrichment region is adjusted, allowing ions that originally accumulated in the non-target ion enrichment region to be selected and then pass through the first ion transfer port for further transport to the ion dissociation device and the second channel. This process continues until all ions in the first channel are analyzed. Therefore, throughout the analysis, the ions in the non-target ion enrichment region are not lost but continue to participate in the subsequent scanning analysis, achieving a 100% utilization efficiency of ions during the ion selection process in the first channel.

Moreover, while the ions within the target mobility range are released, the ions in the non-target ion enrichment region of the first channel can be quickly re-selected, thereby enhancing the analytical efficiency of the tandem ion mobility spectrometer.

In an alternative technical scheme of the disclosure, the non-target ion enrichment regions are located at two ends of the first channel.

According to the tandem ion mobility spectrometer in this disclosure, the non-target ion enrichment regions are arranged at two ends of the first channel. This allows ions with higher mobility and ions with lower mobility to be stored in the two non-target ion enrichment regions at two ends respectively, and the ions within the target ion mobility range accumulate in the target ion enrichment region in the middle of the first channel. This arrangement facilitates the deflection of the ions within the target ion mobility range for release through the first ion transfer port.

In an alternative technical scheme of the disclosure, the ion dissociation device dissociates ions in a target area, and the target area is arranged at an end, near the second ion transfer port, of the second channel and positioned further away from the ion outlet compared to the second ion transfer port.

According to the tandem ion mobility spectrometer in this disclosure, the ions released from the first channel enter the second channel through the second ion transfer port, and then move away from the ion outlet under the control of an electric field applied to the second channel. After the ions are dissociated by the ion dissociation device at an end away from the ion outlet, the resulting fragment ions are scanned and released in order of their ion mobility, moving toward the ion outlet for release to downstream devices.

The tandem ion mobility spectrometer in this disclosure comprises a target area set outside the ion migration path, allowing it to function as a traditional UMA ion mobility spectrometer and, through adjustments in field strength distribution, to enable the dissociation of ions in the target area followed by ion mobility analysis of the resulting fragment ions.

In an alternative technical scheme of the disclosure, the power supply is configured to apply a third electric field to the second channel corresponding to the target area to confine ions to the target area.

According to the tandem ion mobility spectrometer in this disclosure, the ions within the target mobility range are confined in the target area at the end. An ion dissociation device designed to dissociate ions confined to a certain area, such as infrared multiphoton dissociation device or ultraviolet photon dissociation device, can be utilized to dissociate the ions in the target area. The arrangement of the target area allows the tandem ion mobility spectrometer to be compatible with a wider variety of ion dissociation devices, enabling the photodissociation of ions without interfering with the migration paths of other ions.

In an alternative technical scheme of the disclosure, the ion dissociation device dissociates ions in the target area, and the target area is arranged between the first ion transfer port and the second ion transfer port.

According to the tandem ion mobility spectrometer in this disclosure, the target area is arranged outside the first channel and the second channel, thereby not occupying space within the channels. By controlling the electric fields applied at the first ion transfer port and the second ion transfer port, ions can be accelerated to collide with gas molecules, enabling dynamic dissociation of the ions.

In an alternative technical scheme of the disclosure, the ion dissociation device dissociates ions in a target area, and the target area is arranged in the second channel and is configured as a section which extends from the second ion transfer port toward the ion outlet.

According to the tandem ion mobility spectrometer in this disclosure, the ion dissociation device is positioned within the second channel corresponding to the second ion transfer port. This arrangement allows for rapid dissociation of ions along the ion migration path, and enables the fragment ions resulting from dissociation to directly undergo ion mobility spectrometry analysis in the second channel.

In an alternative technical scheme of the disclosure, the second channel is configured to arrange the fragment ions at different positions of the second channel in order of ion mobility and release the same through the ion outlet in sequence.

According to the tandem ion mobility spectrometer in this disclosure, scanning and releasing the fragment ions in the second channel allows for the sequential release of the fragment ions in order of their ion mobility to downstream devices, such as a mass spectrometer, for further detection.

In an alternative technical scheme of the disclosure, the ion dissociation device may be one or more of collision-induced dissociation device, electron transfer dissociation device, infrared multiphoton dissociation device, ultraviolet photon dissociation device, radical-induced dissociation device and surface-induced dissociation device.

In a second aspect of the disclosure, an ion mobility analysis method is provided, which is applied to the tandem ion mobility spectrometer in any of the above technical schemes, and comprises the following steps:
an ion selection step: applying a first electric field to the first channel during a first time period, causing ions within a target mobility range to accumulate in a target ion enrichment region of the first channel, and at least part of ions outside the target mobility range to accumulate in a non-target ion enrichment region located at an end of the first channel;
an accumulating ion release step: applying a second electric field to the first channel during a second time period, causing at least part of ions accumulating in the non-target ion enrichment region during the first time period to move toward and pass through the first ion transfer port; and
a dissociation step: receiving and dissociating ions released from the first channel in the ion selection step and/or the accumulating ion release step to generate fragment ions.

In an alternative technical scheme of the disclosure, the ion mobility analysis method further comprises:
a fragment ion analysis step: applying a fourth electric field to the second channel, arranging the fragment ions at different positions of the second channel in order of ion mobility, and releasing the same through the ion outlet of the second channel in sequence.

### DESCRIPTIONS OF THE DRAWINGS

FIG. 1 is a schematic diagram of a basic structure of UMA in a tandem ion mobility spectrometer according to an embodiment of the disclosure;

FIG. 2 is a schematic diagram of an overall structure of a tandem ion mobility spectrometer when an ion dissociation device is in a first position according to an embodiment of the disclosure;

FIG. 3 is a schematic diagram of an overall structure of a tandem ion mobility spectrometer when an ion dissociation device is in a second position according to the disclosure;

FIG. 4 is a schematic diagram of an overall structure of a tandem ion mobility spectrometer when an ion dissociation device is in a third position according to the disclosure;

FIG. 5 is a flowchart of an ion mobility analysis method according to the disclosure;

FIG. 6 is a schematic diagram of how ions are selected in an ion selection method and an accumulating ion release step in an ion mobility analysis method according to the disclosure; and

FIGS. 7 and 8 are schematic diagrams of how a DC electric field is applied to a first channel in an ion selection method and an accumulating ion release step in an ion mobility analysis method according to the disclosure.

List of reference numerals: 1-tandem ion mobility spectrometer; 11-ion dissociation device; 12-first electrode array; 13-second electrode array; 14-third electrode array; 15-fourth electrode array; 2-UMA analyzer; 201-ion inlet; 202a-first ion transfer port; 202b-second ion transfer port; 203-ion outlet; 204-target ion enrichment region; 205-non-target ion enrichment region; 205a-first non-target ion enrichment region; 205b-second non-target ion enrichment region; 206-target area; 3-gas flow supply; 4-power supply; first channel CH1; second channel CH2.

### DETAILED DESCRIPTION

The technical scheme in the embodiments of the disclosure will be clearly and completely described below in combination with attached drawings. Obviously, the described embodiments are only part of the embodiments of the disclosure, not all of them. Based on the embodiments of the disclosure, all other embodiments obtained by those of ordinary skill in the art without making creative labor shall belong to the scope of protection of the disclosure.

### Terminology and Explanations

In an ion scanning step, “scan release” refers to the sequential release of ions with different mobilities or mobility ranges, or ions with different mass numbers or mass number ranges. The order of release may be either from high to low or from low to high, and specific mobilities/mass numbers or ranges may be skipped in between.

This embodiment provides a tandem ion mobility spectrometer and an ion mobility analysis method suitable for the tandem ion mobility spectrometer.

### Tandem Ion Mobility Spectrometer

FIG. 1 shows a hardware structure of a UMA analyzer 2 in a tandem ion mobility spectrometer provided by this embodiment. On the basis of the UMA analyzer 2 in FIG. 1, the tandem ion mobility spectrometer provided in this embodiment further incorporates an ion dissociation device (not shown in FIG. 1) arranged in the UMA analyzer 2 for receiving and dissociating ions released by a first channel CH1 of the UMA analyzer 2 and releasing fragment ions resulting from dissociation to a second channel CH2.

Referring to FIG. 1, the UMA analyzer 2 of the tandem ion mobility spectrometer in this embodiment comprises four electrode arrays (first electrode array 12, second electrode array 13, third electrode array 14 and fourth electrode array 15 from top to bottom in FIG. 1) arranged in parallel. Here, the first electrode array 12 and the second electrode array 13 are opposite to each other, and an ion channel defined by the first electrode array 12 and the second electrode array 13 is the first channel CH1. The third electrode array 14 and the fourth electrode array 15 are opposite to each other, and an ion channel defined by the third electrode array 14 and the fourth electrode array 15 is the second channel CH2.

The first channel CH1 has an ion inlet 201 and a first ion transfer port 202a. The ion inlet 201 is arranged in the first electrode array 12 near an upstream side of the first channel CH1, and the first ion transfer port 202a is arranged in the second electrode array 13 adjacent to the second channel CH2. The second channel CH2 has an ion outlet 203 and a second ion transfer port 202b. The second ion transfer port 202b is arranged in the third electrode array 14 adjacent to the first channel CH1. The ion outlet 203 is arranged in the fourth electrode array 15 near a downstream side of the second channel CH2. The first ion transfer port 202a and the second ion transfer port 202b are correspondingly arranged to communicate the first channel CH1 and the second channel CH2. The ion inlet 201 and the ion outlet 203 are correspondingly arranged and are staggered with respect to the first ion transfer port 202a and the second ion transfer port 202b. This configuration creates a U-shaped channel that sequentially passes through the ion inlet 201, the first ion transfer port 202a, the second ion transfer port 202b, and the ion outlet 203, forming a U-type ion mobility analyzer.

The gas flow supply 3 introduces gas flow into both the first channel CH1 and the second channel CH2, with the flow direction oriented horizontally as shown in FIG. 1. The power supply 4 is electrically connected with the first electrode array 12, the second electrode array 13, the third electrode array 14 and the fourth electrode array 15, and can apply an electric field force to ions in the first channel and the second channel which is opposite to the direction of a force exerted by the gas flow on the ions. The field strength distribution in the first channel CH1 and the second channel CH2 can be adjusted by controlling the power supply 4, so as to control the balance between the gas flow propulsion and electric field confinement in the first channel CH1 and the second channel CH2.

In the tandem ion mobility spectrometer of this embodiment, the balance between the gas flow propulsion and electric field confinement is oriented horizontally as shown in FIG. 1, perpendicular to the upstream-downstream direction from the ion inlet 201 to the ion outlet 203. Therefore, when ions do not meet the conditions necessary for achieving the balance between the gas flow propulsion and electric field confinement, the ions can escape from openings at two ends in the horizontal direction and be removed or killed, rather than being further transported to the downstream side. Between the first channel CH1 and the second channel CH2, ions in the first channel CHI can be transferred or transported from the first ion transfer port 202a and the second ion transfer port 202b into the second channel CH2 using either a “dipole DC” electric field or a deflection DC electric field.

The principles for implementing the basic functions of storing, accumulating, moving, and separating ions in the first channel CHI and the second channel CH2 of the UMA analyzer 2 can be found in prior patent applications CN109003877A, CN109003876A, CN115223844A, PCT/CN2023/116312, which will not be elaborated upon here.

Referring to FIG. 1, the conventional migration path of ions in the UMA analyzer 2 can be described as follows: ions generated by an upstream device enter the ion inlet 201 perpendicular to the electrode arrays. Due to the staggered arrangement of the ion inlet 201 and the first ion transfer port 202a, ions within a first mobility range, under the balanced effect of the gas flow propulsion and electric field confinement, initially move along the first channel CH1 toward the first ion transfer port 202a. By altering the electric field distribution applied in the first channel CH1, the ions can be arranged at different positions along the length of the first channel CHI according to their ion mobility. Subsequently, by applying a dipole DC electric field at the first ion transfer port 202a and the second ion transfer port 202b, some qualifying ions can be deflected at the first ion transfer port 202a, entering the second ion transfer port 202b from the first ion transfer port 202a. In the second channel CH2, the ions then move toward the ion outlet 203 in a direction opposite to that of the first channel CH1, and are released toward a downstream device in a direction perpendicular to the electrode arrays.

Here, an ion source can be arranged at the upstream side of the first channel CH1, with ions generated by the ion source entering through the ion inlet 201 of the first channel CH1. The downstream side of the second channel CH2 can be provided with other detection instruments, such as mass spectrometry devices.

In some alternative embodiments, the ion source comprises at least one ion source selected from the group consisting of: (i) electrospray ionization (“ESI”) ion source; (ii) atmospheric pressure photoionization (“APPI”) ion source; (iii) atmospheric pressure chemical ionization (“APCI”) ion source; (iv) matrix-assisted laser desorption ionization (“MALDI”) ion source; (v) laser desorption ionization (“LDI”) ion source; (vi) atmospheric pressure ionization (“API”) ion source; (vii) desorption ionization on silicon (“DIOS”) ion source; (viii) electron impact (“EI”) ion source; (ix) chemical ionization (“CI”) ion source; (x) field ionization (“FI”) ion source; (xi) field desorption (“FD”) ion source; (xii) inductively coupled plasma (“ICP”) ion source; (xiii) fast atom bombardment (“FAB”) ion source; (xiv) liquid secondary ion mass spectrometry (“LSIMS”) ion source; (xv) desorption electrospray ionization (“DESI”) ion source; (xvi) nickel-63 radioactive ion source; (xvii) atmospheric pressure matrix-assisted laser desorption ionization ion source; (xviii) thermal spray ion source; (xix) atmospheric sampling glow discharge ionization (“ASGDI”) ion source; (xx) glow discharge (“GD”) ion source; (xxi) impactor ion source; (xxii) direct analysis in real time (“DART”) ion source; (xxiii) laser spray ionization (“LSI”) ion source; (xxiv) sonic spray ionization (“SSI”) ion source; (xxv) matrix-assisted inlet ionization (“MAII”) ion source; (xxvi) solvent-assisted inlet ionization (“SAII”) ion source; (xxvii) Penning ionization ion source; (xxviii) laser ablation electrospray ionization (“LAESI”) ion source; (xxix) He plasma (HePl) ion source. Preferably, the ion source may be an ESI ion source, a MALDI ion source, a DART ion source, or a LAESI ion source, all of which operate at ambient pressure or in real time.

The mass spectrometry device may be one or more of a quadrupole mass analyzer, a time-of-flight mass spectrometer, a Fourier transform mass spectrometer, an ion trap mass spectrometer, or a magnetic mass spectrometer.

Based on the hardware structure of the UMA analyzer 2, the tandem ion mobility spectrometer in this embodiment further comprises an ion dissociation device (not shown in FIG. 1, but will be specifically illustrated in FIGS. 2-4) configured to receive and dissociate ions from the first channel CH1 and release fragment ions generated by dissociation to the second channel CH2.

The ion dissociation device may be an additional device installed on the hardware structure of the UMA analyzer 2, such as an additional collision-induced dissociation device, electron transfer dissociation device, infrared multiphoton dissociation device, ultraviolet photon dissociation device, radical-induced dissociation device, or surface-induced dissociation device. Alternatively, the existing hardware structure of the UMA analyzer 2 may be used, and through electric field control, ions can be sharply accelerated in certain areas, causing collisions with gas molecules that lead to dissociation. In some alternative embodiments, a target area is also formed within the UMA analyzer 2 (not shown in FIG. 1, but will be specifically illustrated in FIGS. 2-4), and the ion dissociation device may be arranged within or near the target area to dissociate ions present in the target area. The target area may be positioned at any location on a downstream side of the first ion transfer port 202a of the first channel CH1.

In some other alternative embodiments, the ion dissociation device may also comprise one or more ion dissociation devices selected from the group consisting of: collision-induced dissociation (CID) device; surface-induced dissociation (SID) device; electron transfer dissociation (ETD) device; electron capture dissociation (ECD) device; electron collision or impact dissociation device; photo-induced dissociation (PID) device; laser-induced dissociation device; infrared radiation-induced dissociation device; ultraviolet radiation-induced dissociation device; nozzle-separator interface dissociation device; in-source dissociation device; in-source collision-induced dissociation device; thermal or temperature source dissociation device; electric field-induced dissociation device; magnetic field-induced dissociation device; enzymatic digestion or degradation dissociation device; ion-ion reaction dissociation device; ion-molecule reaction dissociation device; ion-atom reaction dissociation device; ion metastable ion reaction dissociation device; ion metastable molecule reaction dissociation device; and electron ionization dissociation (EID) device.

FIGS. 2-4 illustrate overall structures of a tandem ion mobility spectrometer 1 with an ion dissociation device 11 or target area arranged at different positions. The following examples, in conjunction with the figures, demonstrate the migration path of ions in the tandem ion mobility spectrometer 1 when the ion dissociation device 11 is arranged at various positions within the UMA analyzer 2.

As shown in FIG. 2, a target area 206 is arranged at an end, near the second ion transfer port 202b, of the second channel CH2 and positioned further away from the ion outlet 203 compared to the second ion transfer port 202b. The ions released from the first channel CH1 enter the second channel CH2 through the second ion transfer port 202b, and then move away from the ion outlet 203 under the control of an electric field applied to the second channel CH2. After the ions are dissociated by the ion dissociation device 11 at an end away from the ion outlet 203, the resulting fragment ions are scanned and released in order of their ion mobility, moving toward the ion outlet 203 for release to downstream devices.

As an alternative embodiment, the power supply 4 is configured to apply a third electric field to the second channel CH2 corresponding to the target area 206, which confines the ions within the target mobility range in the target area 206, so that an ion dissociation device 11 designed to dissociate ions confined to a certain area, such as infrared multiphoton dissociation device or ultraviolet photon dissociation device, can be utilized to dissociate the ions in the target area 206. For example, a laser emission device can be arranged within the electrode arrays of the second channel CH2 of the target area 206, or outside the electrode arrays, enabling the laser to be emitted directly or through gaps between the electrode arrays into the channel, facilitating photodissociation of the ions confined in the target area 206.

The tandem ion mobility spectrometer in this embodiment comprises a target area 206 set outside the ion migration path, allowing it to function as a traditional UMA ion mobility spectrometer and, through adjustments in field strength distribution, to enable the dissociation of ions in the target area 206 followed by ion mobility analysis of the resulting fragment ions. This allows for the dissociation of ions without interfering with the migration paths of other ions. Since the ions are confined and stationary in the target area 206, ion dissociation devices 11 operating at frequencies different from the working frequency of the UMA can be applied, allowing the tandem ion mobility spectrometer of this disclosure to be compatible with a wider variety of ion dissociation devices 11.

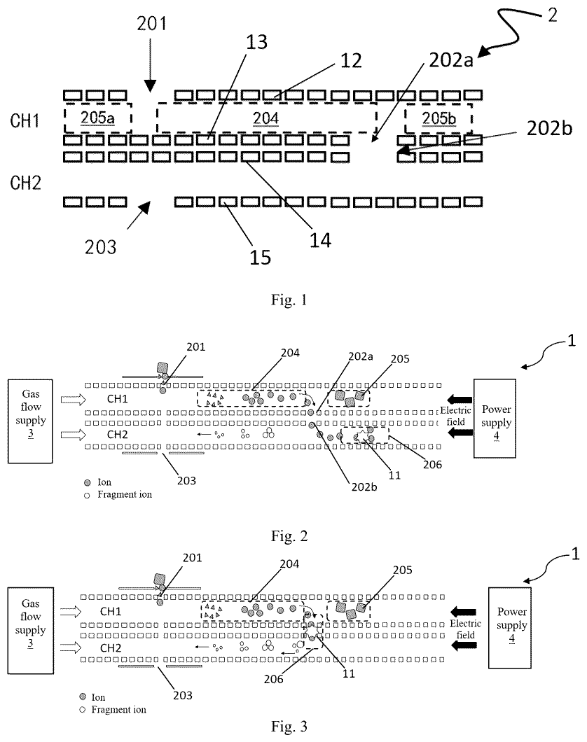

As shown in FIG. 3, the target area 206 is arranged between the first ion transfer port 202a the second ion transfer port 202b. Positioning the target area 206 outside the first channel CH1 and the second channel CH2 avoids occupation of the space within the channels. According to this embodiment, by controlling the electric fields applied at the first ion transfer port 202a and the second ion transfer port 202b, ions can be accelerated to collide with gas molecules, enabling dynamic dissociation of the ions.

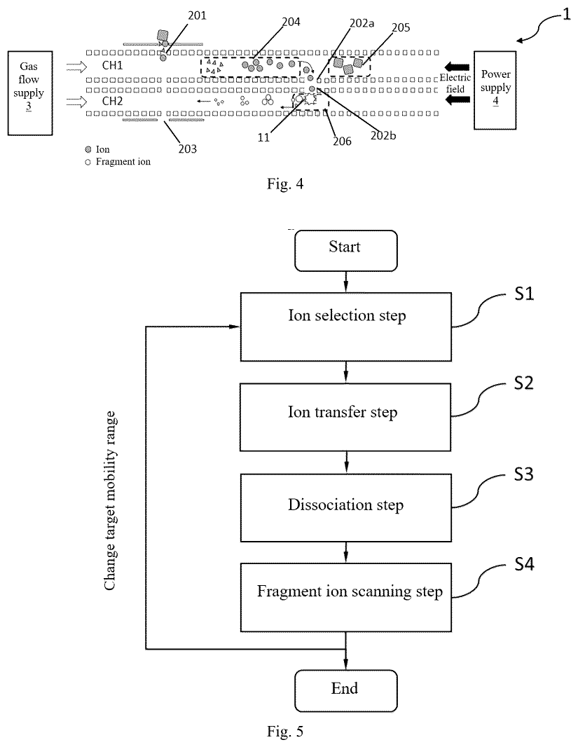

As shown in FIG. 4, the target area 206 is arranged in the second channel CH2 and is configured as a section which extends from the second ion transfer port 202b toward the ion outlet 203. The ion dissociation device 11 is positioned within the second channel CH2 corresponding to the second ion transfer port 202b. This arrangement allows for rapid dissociation of ions along the ion migration path, and enables the fragment ions resulting from dissociation to directly undergo ion mobility spectrometry analysis in the second channel CH2.

Based on the tandem ion mobility spectrometer 1 in this embodiment, the following describes an ion mobility analysis method suitable for the tandem ion mobility spectrometer 1, along with the electric field configuration of the power supply 4 of the tandem ion mobility spectrometer 1 in the first channel CH1 and the second channel CH2 during the execution of the ion mobility analysis method, in conjunction with the accompanying drawings.

### Ion Mobility Analysis Method

In a traditional scanning mode used by U-shaped ion mobility analyzers, each ion mobility spectrum must scan ions across the entire mobility range during the analysis step. This process is time-consuming, and for ions with relatively concentrated mobility, they tend to be more densely distributed, resulting in a significant space charge effect.

The ion mobility analysis method provided in this embodiment is shown in FIG. 5.

The ion mobility analysis method comprises the following steps:
an ion selection step S1: applying a first electric field to the first channel CH1 during a first time period, causing ions within a target mobility range to accumulate in a target ion enrichment region 204 of the first channel CH1, and at least part of ions outside a first mobility range to accumulate in a non-target ion enrichment region 205 located at an end of the first channel CH1;
an ion transfer step S2: transferring ions within the target mobility range in the target ion enrichment region 204 to the second channel CH2;
a dissociation step S3: receiving and dissociating ions released from the first channel CH1 in the ion selection step S1, and releasing fragment ions generated by dissociation to the second channel CH2; and
a fragment ion scanning step S4: applying a fourth electric field to the second channel CH2, arranging the fragment ions at different positions of the second channel CH2 in order of ion mobility, and releasing the same through the ion outlet 203 of the second channel CH2 in sequence.

Next, the target mobility range is changed and the above steps S1-S4 are repeated. During the repetition of these steps, the target mobility range can be adjusted to correspond to the ions which originally accumulated in the non-target ion enrichment region 205, specifically comprising: an accumulating ion release step S5: applying a second electric field to the first channel CHI during a second time period, causing at least part of ions accumulating in the non-target ion enrichment region 205 during the first time period to move toward and pass through the first ion transfer port 202a;
a dissociation step S6: receiving and dissociating ions released from the first channel CH1 in the accumulating ion release step S5, and releasing fragment ions generated by dissociation to the second channel CH2; and
a fragment ion scanning step S7: applying a fourth electric field to the second channel CH2, arranging the fragment ions at different positions of the second channel CH2 in order of ion mobility, and releasing the same through the ion outlet 203 of the second channel CH2 in sequence.

In some embodiments, the dissociation step S3 and the fragment ion scanning step S4 can be performed only for ions in a certain mobility range and do not need to be repeated in every cycle.

In the ion selection step S1, ions across the entire mobility range can accumulate in the first channel CH1. Here, ions within the target mobility range accumulate in the target ion enrichment region 204 of the first channel CH1, specifically in a main section of the first channel CHI from the ion inlet 201 to the first ion transfer port 202a.

Ions that do not belong to the target mobility range accumulate in the non-target ion enrichment region 205. In this embodiment, an example is illustrated with the non-target ion enrichment regions 205 located at both ends of the first channel CH1. Specifically, the non-target ion enrichment regions 205 comprise a first non-target ion enrichment region 205a located at an end, near the ion inlet 201, of the first channel CH1 and a second non-target ion enrichment region 205b located at an end, near the first ion transfer port 202a, of the first channel CH1.

The target mobility ranges set for different time periods can be determined based on a predetermined ion mobility spectrometry-mass spectrometry two-dimensional heat map or can be freely selected based on actual analytical needs, which is not limited here. In alternative embodiments, for some ions that enter the first channel CH1 and do not belong to the target mobility range, these ions can also be filtered out from the two ends of the first channel CH1.

In the accumulating ion release step S5, after the ions within the first mobility range in the ion selection step S1 are released, the electric field applied by the power supply 4 in the first channel CHI is adjusted to the second electric field. This allows the ions accumulating in the non-target ion enrichment region 205 to move back into the target ion enrichment region 204 within the first channel CH1. Next, the second electric field can be configured such that the ions in a second mobility range within the target mobility range correspond exactly to an electric field strength range near the first ion transfer port 202a, thereby facilitating a second round of ion selection and release.

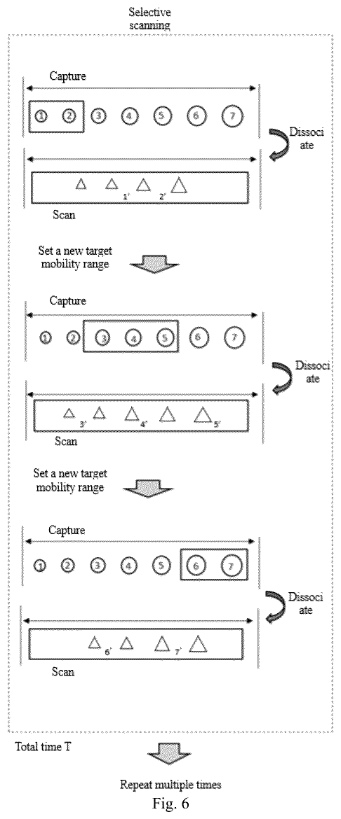

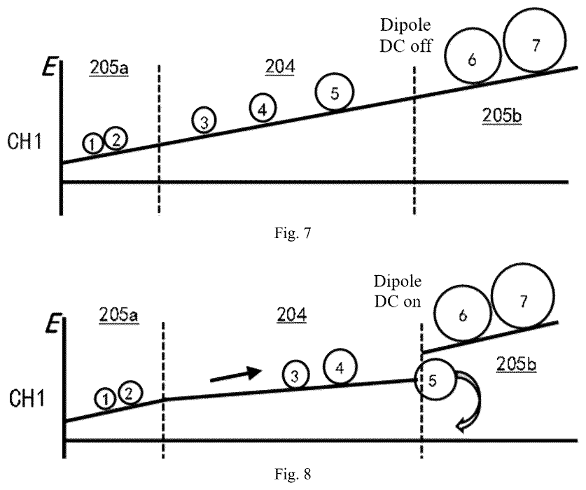

FIG. 6 is a schematic diagram of how ions are selected over multiple cycles in an ion mobility analysis method according to the disclosure. FIGS. 7 and 8 are schematic diagrams of how a DC electric field is applied to a first channel CH1 in an accumulating ion release step S5 in an ion mobility analysis method according to the disclosure. FIGS. 6-8 use an example of seven ions with varying mobilities, where straight or segmented lines in coordinate systems of FIGS. 6-8 represent the DC electric field strength distribution in a first channel CH1.

Referring to FIG. 6, the first cycle of the ion selection step S1 is performed first, and the target mobility range of the first channel CH1 is set to match the ion mobilities of ions 1 and 2; ions 1 and 2 accumulate in the target ion enrichment region 204, while ions 3 through 7 accumulate in the non-target ion enrichment region 205 of the first channel CH1; subsequently, ions 1 and 2, accumulating in the target ion enrichment region 204, are released through the first ion transfer port 202a. Ions 1 and 2 can be released all at once to the ion dissociation device 11 for dissociation, or they can be released in a scanning manner. In the implementation where ions 1 and 2 are subjected to scan release, after completing the dissociation of ion 1 and releasing the fragment ions through the second channel CH2, the first channel CHI then releases ion 2 to the ion dissociation device 11 for dissociation.

For instance, a linear electric field can be applied in the second channel CH2, with a smaller field strength on the left side and a larger field strength on the right side. The scan release process can be completed by keeping the field strength on the right side constant while increasing the field strength on the left side.

Referring to FIGS. 6 and 7, in the second cycle, that is, during the accumulating ion release step S5, a new target mobility range is set, matching the ion mobilities of ions 3 to 5. Ions 3 to 5, originally accumulating in the non-target ion enrichment region 205, will be first transferred to the target ion enrichment region 204, along with ions 3 to 5 entering through the ion inlet 201 during the second cycle, accumulating in the target ion enrichment region 204.

It should be noted that in this embodiment, the target ion enrichment region 204 refers to a region from the ion inlet 201 of the first channel CHI to the first ion transfer port 202a, while the non-target ion enrichment regions 205 are located at both ends of the first channel CH1, comprising the first non-target ion enrichment region 205a, which extends from the ion inlet 201 to one end opening of the first channel CH1, and the second non-target ion enrichment region 205b, which extends from the first ion transfer port 202a to the other end opening of the first channel CH1. Referring to FIG. 7, during the execution of the accumulating ion release step S5 of the second cycle, ions that are not within the target mobility range in the first channel CH1, specifically ions 1, 2, 6, and 7 as shown in FIG. 7, are stored in the non-target ion enrichment region 205. Here, the higher-mobility ions 1 and 2 are stored in the first non-target ion enrichment region 205a, which is closer to the ion inlet 201, while the lower-mobility ions 6 and 7 are stored in the second non-target ion enrichment region 205b, which is closer to the first ion transfer port 202a.

When executing the accumulating ion release step S5 of the second cycle, a linear DC electric field is applied overall in the horizontal direction of the first channel CH1 (i.e., along the length of the UMA analyzer 2) as shown in the accompanying figures. In the first non-target ion enrichment region 205a, due to the lower electric field strength, the ions experience a smaller electric field force. Ions 1 and 2, which have smaller collision cross sections (CCS) and thus higher ion mobilities, can achieve a balance between the gas flow and electric field force and be stored in this region. In the target ion enrichment region 204 located between the first non-target ion enrichment region 205a and the second non-target ion enrichment region 205b, the electric field strength is moderate. Consequently, ions 3, 4, and 5, which have moderate mobilities, accumulate in the target ion enrichment region 204 of the first channel CH1. In the second non-target ion enrichment region 205b, due to the higher electric field strength, the ions experience a larger electric field force. Ions 6 and 7, which have larger CCS and thus lower ion mobilities, can achieve a balance between the gas flow and electric field force and be stored in the second non-target ion enrichment region 205b. Referring to FIG. 7, it is clear that in this embodiment, different areas along the length of the first channel CH1 can store ions. In the ion enrichment process of the ion selection step S1, the gradient of the DC electric field can be set to a low value (for example, a DC electric field that linearly varies across the entire target ion enrichment region 204 as shown in FIG. 7). This allows ions within the target mobility range to be distributed more diffusely along the length of the target ion enrichment region 204, rather than being concentrated in a specific area. This approach effectively reduces spatial charge effects and enhances the resolution for low-abundance ions.

Referring to FIG. 8, after the fragment ions resulting from dissociation released from the first channel CH1 are fully released in the second channel CH2, the ion transfer step S2 of the second cycle is executed. The ions from the target ion enrichment region 204 of the first channel CH1 are released again through the first ion transfer port 202a.

It should be noted that in this embodiment, the UMA analyzer 2 can quickly complete the transfer of ions between the first channel CH1 and the second channel CH2 by adjusting the DC electric field distributed across the electrode arrays and the dipole DC electric field around the first ion transfer port 202a, thereby improving the duty cycle. Specifically, as shown in FIG. 8, the electric field at the first ion transfer port 202a can be continuously reduced while activating the dipole DC electric field, allowing ions 3 to 5 to move quickly to this position and be released through the first ion transfer port 202a.

In some embodiments, the first ion transfer port 202a can also be closed at certain times to filter out ions of certain mobilities or mobility ranges. By filtering out unwanted ions during the transfer process, it allows for highly effective accumulation of ions that are targeted for analysis.

In some other embodiments, by either eliminating the DC electric field in the non-target ion enrichment region 205 or applying a radial DC offset, ions within the non-target ion enrichment region 205, or some ions originating from the target ion enrichment region, can be removed. Specifically, ions can be removed from the second non-target ion enrichment region 205b by eliminating the DC electric field (with gas flow carrying the ions away), or ions from either the first non-target ion enrichment region 205a or the second non-target ion enrichment region 205b can be cleared by applying a radial DC bias. These methods allow for convenient removal of temporarily stored ions, which are easier to implement compared to TIMS.

After the ions are selected and released from the first channel CH1, the dissociation step S6 is performed. In the dissociation step S6, the dissociation location can be anywhere downstream of the first ion transfer port 202a in the UMA analyzer 2. In some alternative approaches, the dissociation location can be set at the position of the aforementioned target area 206, such as at the end, away from the ion outlet 203, of the second channel CH2 or between the first ion transfer port 202a and the second ion transfer port 202b. Alternatively, it can also be set within the second channel CH2 and configured as a section which extends from the second ion transfer port 202b toward the ion outlet 203.

In some alternative embodiments, when the target area 206 is set at the end, away from the ion outlet 203, of the second channel CH2, the dissociation step S6 further comprises: applying a third electric field to the second channel CH2 corresponding to the target area 206, which confines the ions within the target area 206. The third electric field may, for example, be a radio frequency field which creates an ion trap at the target area 206 to confine the ions inside, or a DC electric field with a large gradient. In this case, infrared multiphoton dissociation or ultraviolet photon dissociation devices can be used to emit dissociation light toward the confined ions, thereby achieving ion dissociation.

The fragment ions resulting from dissociation can still be confined to the target position, allowing the fragment ion scanning step S7 to be executed after a certain period of time, once all ions within the target area 206 are dissociated; specifically, applying a fourth electric field to the second channel CH2, arranging the fragment ions at different positions of the second channel CH2 in order of ion mobility, and releasing the same through the ion outlet 203 of the second channel CH2 in sequence.

Specifically, during the fragment ion scanning step S7, the electric field in the second channel CH2 operates in a scanning mode, allowing fragment ions in the second channel CH2 to be scanned and released to the ion outlet 203 in order of mobility.

Because the UMA analyzer 2 features dual channels with independent control, the dissociation step S3 and the fragment ion analysis step S4 can be conducted simultaneously with the ion enrichment process in the accumulating ion release step S5. Specifically, while the second channel CH2 analyzes and releases fragment ions, target ions within the target mobility range for the next dissociation step S3 are accumulating in the target ion enrichment region 204 in the first channel CH1. Further, the target ion enrichment region 204 can receive target ions continuously obtained from the ion inlet 201 that fall within the target mobility range, as well as ions from the non-target ion enrichment region 205 at both ends that were not within the target mobility range in the previous phase but now fall within the adjusted target mobility range. This process design allows for efficient coordination of ion accumulation and release within the dual channels, balancing ion utilization efficiency and scanning speed.

In this way, the ion mobility analysis method provided by this embodiment can segregate ions in the first channel CH1 into multiple groups based on their mobilities, and store ions within the target mobility range and those outside of it in different areas. This enables efficient use of various areas along the length of the first channel CH1 for ion storage, and allows fragment ions, resulting from the dissociation of ions within various target mobility ranges in batches during the dissociation step S3, to be introduced into the second channel CH2 for analysis, thereby avoiding excessive concentration of ions and reducing spatial charge effects. Moreover, although the first channel CH1 selects ions within a specific mobility range at a time, ions of other mobilities are not lost during this selection process. Instead, they are temporarily stored in the non-target ion enrichment region 205, and will enter the ion dissociation device 11 subsequently for dissociation and then enter the second channel CH2 for analysis. This approach can further enhance the duty cycle of the tandem ion mobility spectrometer 1.

According to the tandem ion mobility spectrometer 1 provided in this embodiment, a dissociation device is added to the basic structure of the UMA to form a cascade ion mobility analyzer. This allows for ion mobility spectrum analysis of ions within the target mobility range as well as fragment ions resulting from dissociation of the ions, improving the ability to identify ions. By employing a mode of simultaneous accumulation and scan release using the first channel CH1 and the second channel CH2, ions outside the target mobility range can be temporarily stored in the non-target ion enrichment region 205, allowing for the utilization of nearly all ions and achieving close to 100% ion utilization efficiency.

Foregoing descriptions are only optional embodiments of the present disclosure and are not intended to limit the present disclosure. Any modification, equivalent replacement, or improvement within spirit and principle of the present disclosure should be included in the protection scope of the present disclosure.

What is claimed is:

1. A tandem ion mobility spectrometer, comprising:
a first channel having a first electrode array and a second electrode array which are positioned opposite each other, the first electrode array being provided with an ion inlet, the second electrode array being provided with a first ion transfer port, and the ion inlet and the first ion transfer port being staggered in an extending direction of the first channel;
a second channel having a third electrode array and a fourth electrode array which are positioned opposite each other, the third electrode array being provided with a second ion transfer port, the fourth electrode array being provided with an ion outlet, the first ion transfer port being connected with the second ion transfer port, and in an extending direction of the second channel, the ion outlet being disposed in a staggered way on a side, near the ion inlet, of the second ion transfer port;
a gas flow supply which supplies gas flow to the first channel and the second channel;
a power supply electrically connected with the first electrode array, the second electrode array, the third electrode array and the fourth electrode array, and configured to apply an electric field force to ions in the first channel and the second channel which is opposite to a direction of a force exerted by the gas flow on the ions; and
an ion dissociation device configured to receive and dissociate ions from the first channel and release fragment ions generated by dissociation to the second channel.

2. The tandem ion mobility spectrometer according to claim 1, wherein the power supply is configured to:
apply a first electric field to the first channel during a first time period, causing ions within a target mobility range to accumulate in a target ion enrichment region of the first channel, and at least part of ions outside the target mobility range to accumulate in a non-target ion enrichment region located at an end of the first channel; and
apply a second electric field to the first channel during a second time period, causing at least part of ions accumulating in the non-target ion enrichment region during the first time period to move toward and pass through the first ion transfer port.

3. The tandem ion mobility spectrometer according to claim 2, wherein the non-target ion enrichment regions are located at two ends of the first channel.

4. The tandem ion mobility spectrometer according to claim 1, wherein the ion dissociation device dissociates ions in a target area, and the target area is arranged at an end, near the second ion transfer port, of the second channel and positioned further away from the ion outlet compared to the second ion transfer port.

5. The tandem ion mobility spectrometer according to claim 4, wherein the power supply is configured to:
apply a third electric field to the second channel corresponding to the target area to confine ions to the target area.

6. The tandem ion mobility spectrometer according to claim 1, wherein the ion dissociation device dissociates ions in a target area, and the target area is arranged between the first ion transfer port and the second ion transfer port.

7. The tandem ion mobility spectrometer according to claim 1, wherein the ion dissociation device dissociates ions in a target area, and the target area is arranged in the second channel and is configured as a section which extends from the second ion transfer port toward the ion outlet.

8. The tandem ion mobility spectrometer according to claim 1, wherein
the second channel is configured to arrange the fragment ions at different positions of the second channel in order of ion mobility and release the same through the ion outlet in sequence.

9. The tandem ion mobility spectrometer according to claim 1, wherein the ion dissociation device is one or more of collision-induced dissociation device, electron transfer dissociation device, infrared multiphoton dissociation device, ultraviolet photon dissociation device, radical-induced dissociation device and surface-induced dissociation device.

10. An ion mobility analysis method, characterized by using the tandem ion mobility spectrometer according to claim 1, comprising the following steps:
an ion selection step: applying a first electric field to the first channel during a first time period, causing ions within a target mobility range to accumulate in a target ion enrichment region of the first channel, and at least part of ions outside the target mobility range to accumulate in a non-target ion enrichment region located at an end of the first channel;
an accumulating ion release step: applying a second electric field to the first channel during a second time period, causing at least part of ions accumulating in the non-target ion enrichment region during the first time period to move toward and pass through the first ion transfer port; and
a dissociation step: receiving and dissociating ions released from the first channel in the ion selection step and/or the accumulating ion release step, and releasing fragment ions generated by dissociation to the second channel.

11. The ion mobility analysis method according to claim 10, further comprising:
a fragment ion scanning step: applying a fourth electric field to the second channel, arranging the fragment ions at different positions of the second channel in order of ion mobility, and releasing the same through the ion outlet of the second channel in sequence.
